(19) United States
(12) Patent Application Publication
(10) Pub. No.: US 2008/0237305 A1
(43) Pub. Date: Oct. 2, 2008

(54) High-Capacity Air Cargo Pallet Using Friction Stir Welding

(76) Inventors: Timothy S. Rennick, Columbus, OH (US); Corey Linden, Columbus, OH (US); Richard P. Granger, New Albany, OH (US); Mark J. Perry, Hilliard, OH (US)

Correspondence Address: BATTELLE MEMORIAL INSTITUTE, 505 KING AVENUE, COLUMBUS, OH, 43201-2693, US

(21) Appl. No.: 11/961,585

(22) Filed: Dec. 20, 2007

Related U.S. Application Data
(60) Provisional application No. 60/877,429, filed on Dec. 28, 2006.

(51) Int. Cl. B23K 20/12

(52) U.S. Cl. 228/112.1

(57) ABSTRACT

This invention relates to methods for making high strength friction stir welded joints. Broadly the invention provides for a method for making a friction stir welded joint including the steps of applying an adhesive to one surface of a first material to be welded; applying a second material to be welded to the adhesive the first material; curing the adhesive; and forming a friction stir weld joint through the cured adhesive by friction stir welding.

### FIELD OF THE INVENTION

This invention relates to methods for making high strength friction stir welded joints. The invention is useful in making high-capacity, long-life air cargo pallets, such as those used by the US military or commercial shippers. The invention increases pallet durability, while pallets are exposed to extreme environments and subjected to routine rough handling.

### BACKGROUND OF THE INVENTION

Current high-capacity air cargo pallets, especially those used by the US military, must balance load capacity and durability against weight and cost. Current designs, utilizing older materials and process technologies, have proven adequate over the years, but rising repair and replacement costs are becoming a significant concern. Skin punctures can lead to water-damaged core material and eventual pallet debonding and delamination. A damaged pallet will eventually fail to function and be condemned.

As an example, the current mainstay of the US military airlift system is designated the 463L air cargo pallet. This air cargo pallet design dates back to April 1963 (4/63). The 463L is constructed of thin aluminum skins (0.063 inch thick on top skin, 0.080 inch thick on bottom skin) that are adhesively bonded to a rigid end-grain balsa wood core material. A hot press is used to accelerate the adhesive curing process and consolidate the sandwich structure. At the same time, these aluminum skins are adhesively bonded to extruded aluminum side rails that then interface with existing military airlift systems when the pallet is placed in service. Care is taken to seal the structure from moisture by applying a polymer sealant at the corners of the mitered side rails. Additionally, the adhesive bond between the aluminum skins and the side rails (a lap-style joint) requires a film adhesive with a carrier fabric to achieve the proper bond thickness and improve the uniformity of bonded joint properties.

### BRIEF DESCRIPTION OF THE INVENTION

The invention relates to an article of manufacture that may be an air cargo pallet with increased durability including thicker skins to reduce skin damage, a moisture-resistant inorganic or organic structural core, and significant improvements in the structural integrity of the pallet, essentially a sandwich structure, by employing friction stir welding. In one embodiment a high-strength, aluminum honeycomb structural core is adhesively bonded to thicker aluminum sheets (skins), which are then friction stir welded to extruded aluminum side rails. Additionally, the pallet includes a central friction stir welded joint, where partial aluminum skins are joined together and also welded to an underlying aluminum channel. The central joint allows use of smaller material sizes and adds strength and stiffness to the structure because of the underlying channel. To achieve friction stir welds of the highest quality, the invention also includes the method of manufacturing the pallet during which adhesive is used to temporarily bond the skins to the core prior to welding and wherein the adhesive is prevented from migrating into and degrading the weld zone.

Alternative embodiments include the use of other core materials, such as high-strength foamed polymer cores, fiber reinforced polymer composite cores, continuous pultruded composite cores, or hybrid organic/inorganic cores such as polymer foam filled metallic honeycomb cores, and a variety of means to exclude the adhesive from the weld region, such as gaskets, o-rings, caulk, double sided foam tape, or integral resin traps or barriers built into the skin or side channel. Further, an adhesive may be unnecessary if the core material is formed in place, expanding to adhere to the skins. Lastly, multiple parallel or crossing channels internal to the pallet, which are then friction stir welded to the skins, may be used to add to the structural properties of the pallet. Friction stir welding makes the addition of inner structural channels possible and effective by joining the skin and channel together along the joint. The side rail and internal channel cross-section itself can be varied to provide different welded joint configuration and different structural behavior (i.e., bending moment of inertia) to suit the application.

The friction stir welded air cargo pallet is typically assembled within a fabrication tray or fixture to ensure proper placement of all components and to support them fully during the two-step process—adhesive bonding of pallet followed by friction stir welding. This tray, which can be moved between different fabrication stations, may be used during the adhesive bonding process, including consolidation and curing of the adhesive, and then transferred to the friction stir welding machine. The tray will also have sides that allow the attachment of clamps and bracing to easily and adequately restrain the pallet during the friction stir welding process. The tray can incorporate thermal insulation to limit heat transfer out of the tray, thus retaining the heat generated during welding to assist in more completely curing the pallet's adhesive, or the tray can be designed to efficiently remove heat from the pallet as it is welded to avoid excessive temperatures that might develop.

Broadly, the invention includes a method for making a friction stir welded joint including the steps of
a. applying an adhesive to one surface of a first material to be welded;
b. applying a second material to be welded to the adhesive the first material;
c. curing the adhesive; and
d. forming a friction stir weld joint through the cured adhesive between at least a portion of the first and second material by friction stir welding. The adhesive is typically a thermoplastic adhesive.
A further embodiment includes a method for making a manufactured product including the steps of
a. assembling the manufactured product and applying adhesive at a joint to be friction stir welded;
b. curing the adhesive; and
c. friction stir welding the joint through the cured adhesive. Typically the manufactured product is a pallet.
A yet further embodiment of the invention includes a method for making a pallet including the steps of
a. providing a fabrication tray;
b. assembling the pallet in the fabrication tray and applying adhesive to a joint to be friction stir welded;
c. curing the adhesive; and
d. friction stir welding the joints through the cured adhesive.
An additional embodiment provides for a manufactured product having friction stir welded joints that is produced according to the methods herein.

Since the joints to be friction stir welded are tightly held by an adhesive, the invention provides for a rigid stable joint at the time of friction stir welding.

### BRIEF DESCRIPTION OF THE DRAWINGS

FIG. 1 is cross-sectional view along one side of the friction stir welded air cargo pallet, showing the high-strength, moisture-resistant core bonded to the thick aluminum skins, which are then friction stir welded to an aluminum side rail.

FIG. 2 is a cross-sectional view of the center section of the friction stir welded air cargo pallet, showing a high-strength, moisture-resistant core and an internal aluminum channel for supporting the interface between adjacent aluminum skin panels.

FIG. 3A and FIG. 3B are views of two different skin panel configurations with FIG. 3A showing one central joint parallel to the edges and

FIG. 3B showing a crossing joint pattern.

FIG. 4 is a depiction of the friction stir welding process as applied to the side rail of the pallet.

FIG. 5 is a depiction of the assembled friction stir welded air cargo pallet as it is supported within a fabrication tray or fixture and ready for welding.

### DETAILED DESCRIPTION OF THE INVENTION

Since the introduction of earlier pallet designs, including the 463L pallet, advances have been made with structural core materials in terms of performance and cost. Foamed polymer cores are of considerably higher-strength than in the past, and cost can be kept down if a continuous production process is used. Alternatively, the metallic honeycomb core material has become more readily available and costs have dropped, too, making these cores comparable to high-strength foamed polymers. The structural properties of these cores are competitive with rigid end-grain balsa, especially when the pallet is treated as a system and thickening of the skins are also possible. The invention accommodates the use of many moisture resistant materials, including organic and inorganic materials.

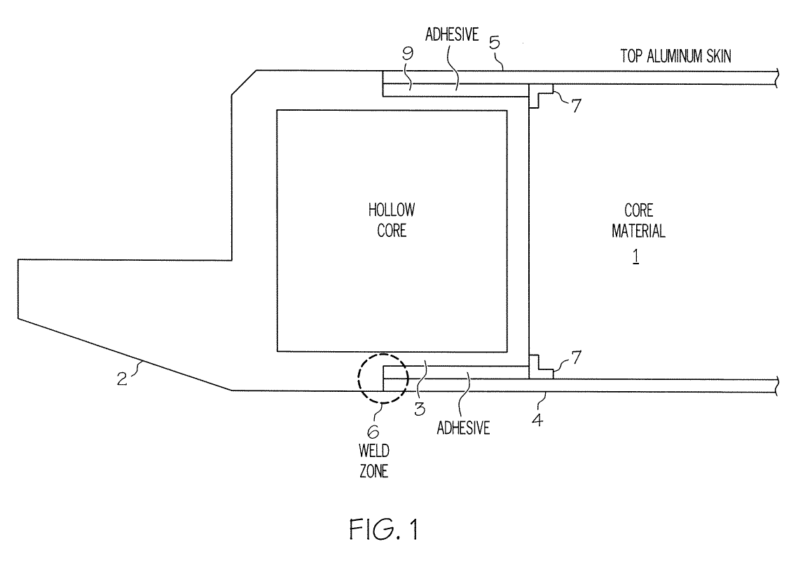

FIG. 1 illustrates a cross-section of the friction stir welded air cargo pallet, showing the high-strength, moisture-resistant core 1 bonded to the upper skin 5 and the lower skin 4 with an adhesive. Side rail 2 is in contact with the core 1 and with the upper and lower skins. The skins may join with the side rail along a shoulder 9 cut in the side rail. These skins and the side rails are metallic materials capable of being friction stir welded to each other. Aluminum is a preferred material due to its lower density.

In fabricating the pallet according to one embodiment of the invention it is desirable to reduce the contact of the adhesive with the weld zone 6. The adhesive may have a negative effect on the quality of the resulting weld. Therefore, a barrier 7 may be used to prevent excess adhesive from migrating to the weld zone from the interface between and skin and the core. A variety of barriers may be envisioned including gaskets, o-rings, caulk, double sided foam tape, or integral resin traps or barriers built into the skin or side channel.

The friction stir weld is conducted along the butt joint formed between the skin and the small side rail shoulder on both the top and bottom of the pallet. This effectively seals the top surface of the pallet, making it one continuous surface. If moisture should enter the sandwich structure, though, the core material will resist its propagation and prevent pallet damage and delamination. The adhesive is also selected to resist moisture and to be tough and absorb impacts without fracture. One preferable type of adhesive to use is a thermoplastic adhesive.

Current pallets use a continuous upper and lower skin. For example, the one-piece skin on the 463 pallet is approximately 7 feet by 9 feet. Very few aluminum mills can produce this material. However, if the skin is half that dimension (e.g., 3.5 feet by 9 feet) many more material suppliers can produce the material leading to greater opportunity for competitive pricing. This logic also applies to the structural core material; although, unlike the skins, undersized core material can be easily joined. Thus, the current invention provides a design and method for incorporating smaller and lower priced material stock size into large pallet and still maintain a continuous surface.

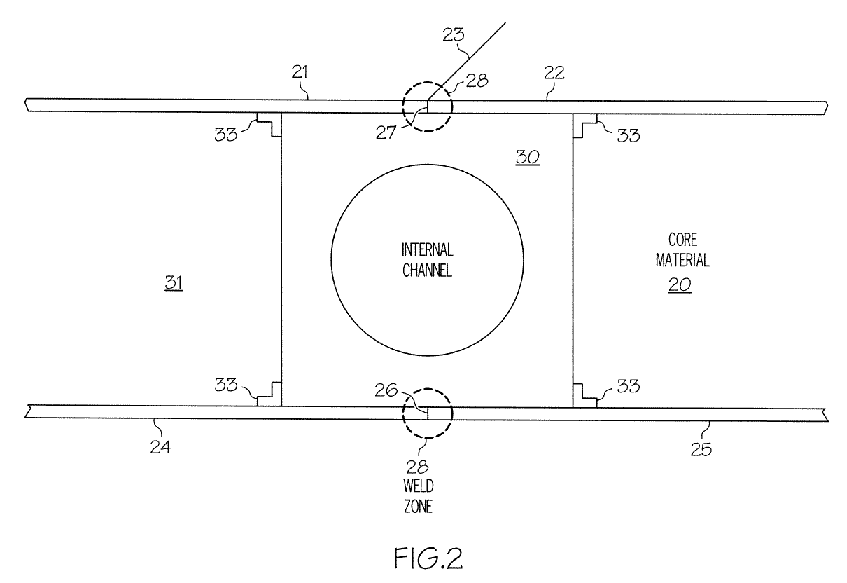

FIG. 2 illustrates a cross-section view of the friction stir welded air cargo pallet utilizing the smaller skin and core members. In this design the high-strength, moisture-resistant core 31 is adhesively bonded to the thick aluminum upper and lower skin panels 21 and 24. Core 20 is adhesively bonded to the thick aluminum upper and lower skin panels 22 and 25. An internal channel 30 is in contact with the core 31 and the core 20 and the skin panels 21 and 22 form a butt joint 27 in contact with the internal channel 30. Likewise, skin panels 24 and 25 form a butt joint 26 on the lower side of the internal channel 30. The upper and lower skins are then friction stir welded to an internal aluminum channel at the butt joints 26 and 27. The internal channel not only adds to the structural integrity of the overall pallet, but it also serves to support the friction stir welding forces that are necessary to join the two upper and two lower skins. Again, a barrier 33 to prevent excess adhesive from entering the weld zones 28 is used, and friction stir welds are required on both the top and bottom of the pallet. The joints may be butt, lap and other joint configuration that can be welded with the friction stir process.

The internal channel is shown in FIG. 2 as a cylinder with a circular cross section that has been flattened on four regions around the circumference. However, the shape of the internal channel may vary. It may be solid or tubular, for example. It generally has an elongated shape to run the length of the center butt joint between panels of the skin, though it could also be cut in shorter sections. The cross section may be round, square, hexagonal or any similar shape that will enable it to support the joint between the skins. An I-beam shape could be used. Moreover, the shape may vary along the length.

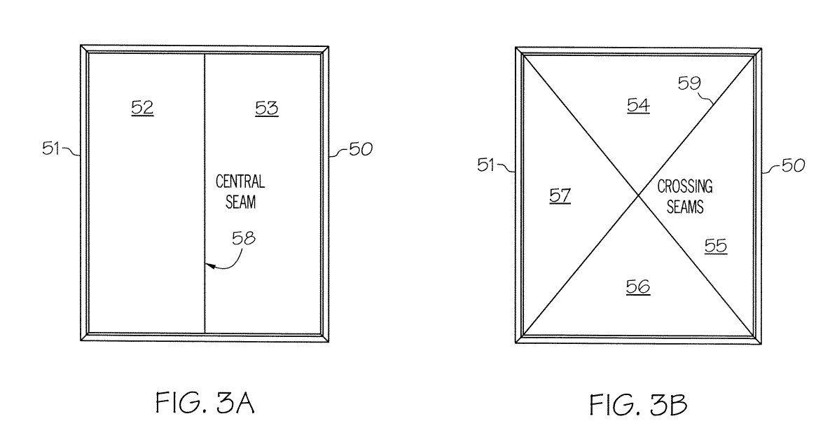

FIGS. 3A and 3B illustrate tow views of different skin configurations on either surface of the pallet. The pallet has side rails 50 and 51 that are substantially parallel to each other. FIG. 3A shows a configuration where two upper skin panels 52 and 53 (or the lower skin panels) are butted together to form one central joint 58. FIG. 3B shows a configuration where four upper skin panels 54-57 (or lower portions) are butted together to form a crossing joint pattern 59. This allows use of smaller material stock sizes and adds structural integrity to the overall pallet. In the latter case, the added structural stiffness and strength is more uniformly distributed with the crossing pattern. Cutting skin stock may be more difficult for the crossing pattern, and may require two different stock widths that are then cut at the necessary bisecting angles.

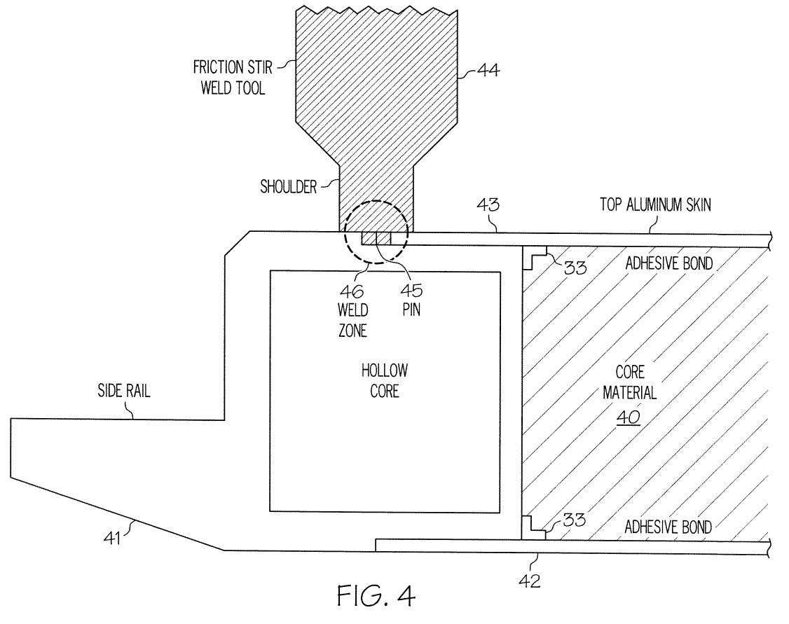

FIG. 4 is depiction of the friction stir welding apparatus and process. In the preferred embodiment, a welding tool 44 is shown working on the upper skin 43 and the side rail 41 to be joined. The tool 44 has a flat shoulder with a smaller diameter center pin 45. Alternatively, other tools with tapered shoulders (with or without a pin) may prove more suitable because they tolerate slight mismatches in the components to be joined. As the tool is rotated and plunged into the metal to be welded, heat is generated that softens the metal, mixing or amalgamating the materials together. Heat generated also conducts outwards from the weld zone 46 and warms the surrounding structure further curing the adhesive used to bond the core to the skins. This warming, though, is limited by the total amount of heat generated by the friction stir welding process and the amount of surrounding metallic material available to absorb it so that the adhesive and core material are not damaged.

Since the development of friction stir welding (such as shown, for example, in U.S. Pat. No. 5,460,317), numerous advances have been made to improve upon this joining process. This joining process is ideally suited to flat panel-type applications where butt, lap, or other joint configurations are needed. Additionally, it is conceivable that this process is capable of being automatically controlled to follow a predefined weld path. The resulting welded joint exhibits exceptional mechanical properties that far surpass that of an adhesively bonded joint. Friction stir welding is a more tolerant welding process than more traditional arc welding. Weld preparation and cleaning is not as critical. Additionally, the material being formed never melts, but is instead mixed plastically so peak temperatures in the weld region are generally lower. However, gross contamination of the weld region, such as excess adhesive used in bonding the core to the skin, should be excluded to achieve the highest quality welds.

To join two components with friction stir welding—in this case, the skins to side rails and internal channels—the two components much be rigidly fixed in place and supported sufficiently to resist the large forces exerted by the friction stir welding machine through the welding tool. Typically, this is conducted by clamping or bracing the components to be welded against a massive steel foundation. Often the amount of clamping and bracing involved in friction stir welding is extensive, especially as the thickness of the material to be welded increases.

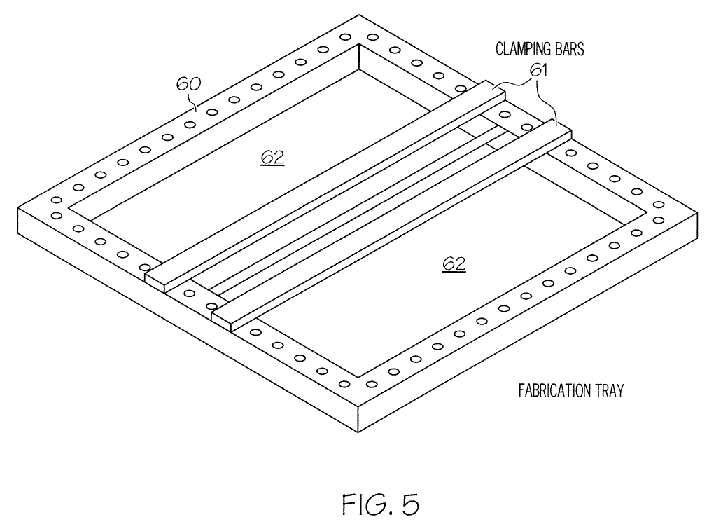

FIG. 5 is a depiction of the assembled friction stir welded air cargo pallet showing upper skin panels 62 as it is held with braces 61 within the fabrication tray 60 and ready for welding. The friction stir welded air cargo pallet will be assembled within the tray to ensure proper placement of all components and support them fully. This tray 60, which can be moved between different fabrication stations, will be used during the adhesive bonding process, including consolidation and curing of the adhesive, and then transferred to the friction stir welding machine. The tray will also have sides that allow the attachment of clamps and bracing to easily and adequately restrain the pallet during the welding process. The tray can incorporate thermal insulation to limit heat transfer out of the tray, thus retaining the heat generated during welding to assist in more completely curing the pallet's adhesive, or the tray can be designed to efficiently remove heat from the pallet as it is welded to avoid excessive temperatures that might develop.

The invention includes an air cargo pallet comprising a moisture-resistant core having upper and lower surfaces and elongated, substantially parallel core sides, side rails adjacent the core sides, upper and lower skin panels covering the upper and lower core surfaces and friction stir welded to the side rails, and an internal channel friction stir welded to the skin panels and supporting the skin panel seam.

The air cargo pallet may be manufactured by providing a moisture-resistant core having upper and lower surfaces and elongated, substantially parallel core sides, providing side rails adjacent the core sides, adhesively bonding upper and lower skin portions to the upper and lower core surfaces and in contact with the side rails at weld regions, preventing the adhesive from contacting the weld regions, and friction stir welding the side rails to the upper and lower skin panels in the weld regions.

While the invention has been described in connection with specific embodiments as shown and described, it is to be understood that numerous changes and modifications may be made therein without departing from the scope and spirit of the invention as set forth in the appended claims.

We claim:

1. A method for making a friction stir welded joint comprising:
a. applying an adhesive to one surface of a first material to be welded;
b. applying a second material to be welded to the adhesive the first material;
c. curing the adhesive; and
d. forming a friction stir weld joint through the cured adhesive between at least a portion of the first and second material by friction stir welding.

2. The method according to claim 1, wherein the adhesive is a thermoplastic adhesive.

3. A method for making a manufactured product comprising:
a. assembling the manufactured product and applying adhesive at a joint to be friction stir welded;
b. curing the adhesive; and
c. friction stir welding the joint through the cured adhesive.

4. The method according to claim 3, wherein the adhesive is a thermoplastic adhesive.

5. The method according to claim 4, wherein the manufactured product is a pallet.

6. A method for making a pallet comprising:
a. providing a fabrication tray;
b. assembling the pallet in the fabrication tray and applying adhesive to a joint to be friction stir welded;
c. curing the adhesive; and
d. friction stir welding the joints through the cured adhesive.

7. The method according to claim 6, wherein the adhesive is a thermoplastic adhesive.

8. A manufactured product having friction stir welded joints produced according to the method of claim 1.
